(19) United States
(12) Patent Application Publication
(10) Pub. No.: US 2016/0231555 A1
(43) Pub. Date: Aug. 11, 2016

(54) Borescope Inspection System

(71) Applicant: Visicon Technologies, Inc., Napa, CA (US)

(72) Inventors: Daniel Freifeld, Napa, CA (US); Ben Hoselton, Napa, CA (US)

(73) Assignee: Visicon Technologies, Inc., Napa, CA (US)

(21) Appl. No.: 15/019,221

(22) Filed: Feb. 9, 2016

Related U.S. Application Data
(60) Provisional application No. 62/113,709, filed on Feb. 9, 2015.

(51) Int. Cl. G02B 23/24; H04N 5/232; H04N 5/225

(52) U.S. Cl. CPC G02B 23/2469; H04N 5/2256; H04N 5/2254; H04N 5/23212; H04N 2005/2255

(57) ABSTRACT

A first borescope for viewing an interior surface of a cylindrical article has an image conducting tube with a beamsplitter cube adjacent a distal end of the image conducting tube. When the article allows light to pass through it, the borescope has a light source effective to provide light illuminating the inner surface from an opposing second side of the beamsplitter cube. A second borescope, useful when the article does not permit light to pass through has an image conducting tube with a reflector. A plurality of optical fibers form a light conduit mounted to optics effective to transmit light from a proximal end of the image conducting tube to the distal end, whereby the light exits through an annulus at the distal end.

### CROSS-REFERENCE TO RELATED PATENT APPLICATION

This patent application claims a benefit to the filing date of U.S. Provisional Patent Application Ser. No. 62/113,709 that was filed on Feb. 9, 2015 and is titled, “Automated Stent Inspection System.” The disclosure of U.S. 62/113,709 is incorporated by reference herein in its entirely.

### BACKGROUND

(1) Field of the Disclosure

Disclosed herein is an optical inspection system utilizing a borescope effective to image the inner bore (or inside diameter) of a part under inspection. More particularly, various embodiments disclose systems to provide uniform lighting and fixed magnification to facilitate use of a computer-based vision system.

(2) Description of Related Art

A borescope is an optical device having a rigid or flexible tube with an eyepiece or video screen at one end and objective lens at the other end. An optical relay, that may be a series of lenses for a rigid tube and optical fibers for a flexible tube, conducts an image viewed at the objective lens to the eyepiece. Representative borescopes are disclosed in U.S. Pat. No. 6,333,812, “Borescope” by Rose et al. and in U.S. Pat. No. 9,074,868, “Automated Borescope Measurement Tip Accuracy Test,” by Bendall et al. Both U.S. Pat. No. 6,333,812 and U.S. Pat. No. 9,074,868 are incorporated by reference herein in their entirties.

Borescopes are commonly used to assess the quality of inner surfaces of a wide variety of industrial components. Such an inner surface may be the inside diameter of a through-hole structure, such as a pipe or a stent, or a blind bore structure, such as a cartridge case. Whether an eyepiece or a video screen is used to view the image, a person is typically required to perform an analysis and determine the surface quality of a component under inspection. One particularly important class of parts that require such inspections are small precision cylindrical components. Medical stents and rifle barrels are two exemplary members of this class. When the cylindrical component has a relatively large inner diameter, it is easier and more practical to insert a traditional camera and lens fully within the cylinder. When the cylindrical component has a relatively small inside diameter, nominally 12 millimeters or less, a borescope is preferred.

Rather than rely on an inspector's judgment, manufacturers of dimension critical components prefer to rely on the more consistent and reliable performance of a computer-based vision system to assure quality. However, current borescope inspection systems generally lack a means to automatically acquire and analyze a set of borescope generated images. Further, the lighting available with current borescopes generally creates too much glare and uneven illumination for machine vision algorithms to make measurements and find defects robustly.

Disclosed herein are borescopes and inspection systems useful with computer-based vision systems that do not suffer the shortcomings of previous devices and systems.

### BRIEF SUMMARY OF THE DISCLOSURE

In accordance with a first embodiment, there is provided a borescope having an image conducting tube with a beamsplitter cube adjacent a distal end of the image conducting tube. This borescope is configured to view an inner surface of an object disposed adjacent a first side of the beamsplitter cube. The borescope has a light source effective to provide light illuminating the inner surface from an opposing second side of the beamsplitter cube.

In accordance with a second embodiment, there is provided a borescope configured to view an inner surface of an object under inspection. This borescope includes an image conducting tube with a reflector adjacent a distal end thereof and an outer tube circumscribing the image conducting tube. This outer tube is capable of independent rotation around the image conducting tube. The borescope further has a plurality of optical fibers forming a light conduit mounted to optics effective to transmit light from a proximal end of the image conducting tube to the distal end thereof, whereby the light exits through an annulus at the distal end. An input window of the light conduit is responsive in shape to collect light from the optical fibers and a motor is effective to rotate the outer tube, reflector and light conduit so as to acquire image data anywhere along 360 degrees of the inner diameter of the object.

The boroscopes may be used in an inspection system for imaging an inner surface of an object where at least a portion of the object has general rotational symmetry. The inspection system includes a source of illumination, a fixture configured to support the object, a rotary stage configured to support the fixture such that rotation of the rotary stage rotates the object about a central cylindrical axis of that portion of the object that is generally rotationally symmetric. A first digital camera and lens are capable of imaging an exterior surface of the object. A borescope has a reflector at its distal end. This reflector redirects a field of view of the borescope to capture a view of the inner surface of the object by a second digital camera located at a proximal end of the borescope. A motion controller collects encoder signals from the rotary stage and using those encoder signals calculates a set of rotary positions at which to trigger the first and second digital cameras to acquire image data. A computer is programmed to receive and process the image data and is also capable of one or more of displaying and performing quality analysis of the processed image data.

### BRIEF DESCRIPTION OF THE SEVERAL VIEWS OF THE DRAWINGS

FIG. 1 is a perspective view of a borescope for use with the inspection system described herein.

FIG. 2 is a flow chart illustrating computer and motion control of the inspection system described herein.

FIG. 3 is a perspective view of a first system to illuminate an inner surface of a work piece being inspected with the inspection system described herein.

FIG. 4 is a perspective view of the inspection system described herein.

FIG. 5 is a perspective view of a second system to illuminate an inner surface of a work piece being inspected with the inspection system described herein.

FIG. 6 is a flow chart illustrating steps of operation for inspection by the systems disclosed herein.

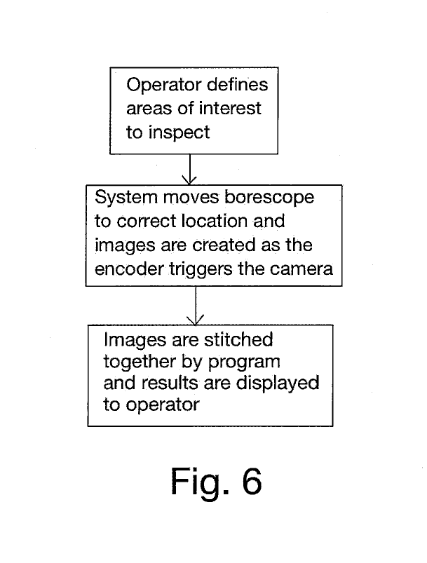

### DETAILED DESCRIPTION

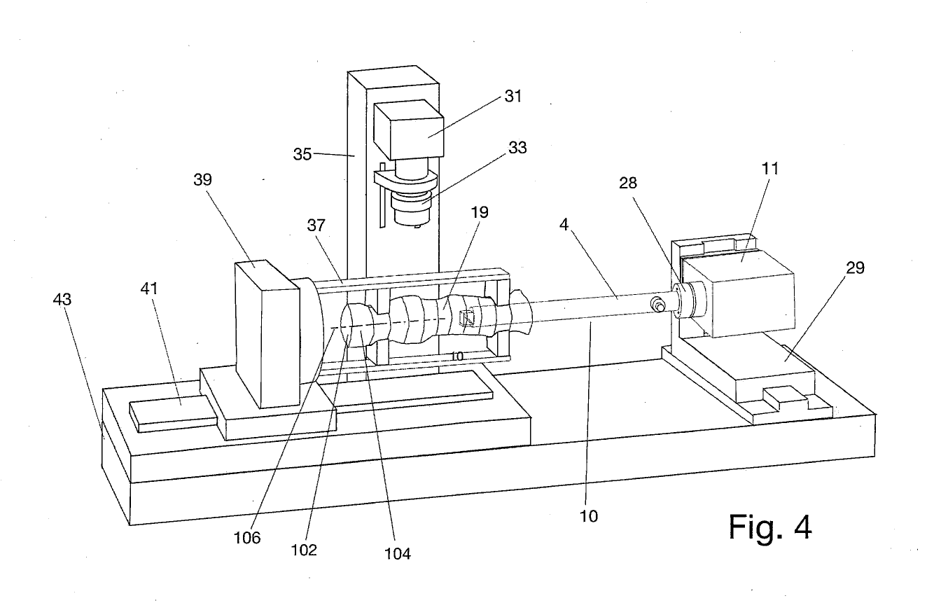

With reference to FIG. 4, the inspection system is particularly suitable for generally cylindrical objects 19 having an inner surface 102 and an outer surface 104. By generally cylindrical, it is meant that at least a portion of the object 100 has rotational symmetry about central cylindrical axis 106. The object may allow light to pass through it, for example by being transparent or translucent, or being a mesh type structure, such as a medical stent. The object may not allow light to pass through it, for example by being a solid metal cartridge case or fluid pipe. Whether or not light may pass through the object impacts the illumination system as discussed below.

The object under inspection is held in a fixture and rotated about its central cylindrical axis by a motorized rotary stage. A borescope is inserted into the object and images are captured sequentially by a digital camera as the object is rotated. A ninety degree (“right angle”) turning prism is affixed to an end of the borescope so that it images the inner wall surface of the generally cylindrical object. An encoder on the rotary stage may be used to trigger the digital camera at appropriate intervals. Each 360 degrees of rotation will create a strip of “unrolled” image. To then capture additional images along the length of the cylinder, a linear motion stage can be used to move the rotary stage holding the fixture and object under inspection iteratively with respect to the borescope until it is fully imaged.

In one preferred embodiment, the digital camera is a line scan camera and is aligned with the right angle prism enabling the camera to build up a line-by-line image of the inner surface. By choosing a line scan camera that acquires a thin line of part image parallel to the central axis of the cylinder, problems with imaging a curved object with a flat area camera sensor can be avoided. If a telecentric stop is placed between the set of relay lenses that comprise the main body of the borescope, the magnification of the taken image will be fixed. A fixed magnification supports better image-to-image strip alignment; especially important when the individual images taken at iterative steps along the x-axis need to be joined together to form a larger whole image that represents a full scan of the inner surface across 360 degrees. Slight rotational mechanical eccentricities of the holding fixture and the inherent lack of perfect cylindricality of typical real-world parts under inspection results in variable working distances of the part to the borescope. The telecentric stop avoids distortion artifacts that might otherwise be caused by changes in magnification. Furthermore machine vision analysis is most effective if the pixels being analyzed are all based on the same magnification.

A uniform illumination approach is achieved by using a beamsplitter cube in place of a simple mirror arrangement and bringing light to the object under inspection from the opposite side of the beamsplitter cube. In embodiments where the cylindrical component under inspection is not fully opaque, such as a medical stent, placing the light source outside the part under inspection and shining light towards the surface being imaged through the beamsplitter cube can create a uniformly illuminated image.

For a more common inspection requirement, where the object being inspected is a generally opaque cylindrical component, bright field illumination may be obtained by bringing light through fiber optics to the beamsplitter cube and driving that light into a light guide placed behind the beamsplitter cube. If the backside of the beamsplitter cube is rounded to conform to the shape of the borescope, a wider angle of bright field illumination coverage can be introduced. A configuration that brings light up and around the rounded beamsplitter cube as well as through the beamsplitter cube using either fiber optics or a clear silvered specially shaped optical manifold can achieve both bright field and dark field illumination in the same borescope. If a color camera is used and different colors of illumination are used for the bright field opposed to the dark field, then both types of image can be obtained and analyzed separately and simultaneously.

For situations where it is preferable to maintain the part being inspected stationary and instead rotate the borescope's field-of-view to create the image strips, the fiber optics can be cleaved right before the prism or beamsplitter cube and light can be transmitted across a precision annular slip ring. If the prism is mounted also on the slip ring it can rotate. A tubular member that transmits torque can be slidably positioned over the entire borescope and used to rotate the reflecting optics and the remaining end of the fiber optics on the other side of the slip ring as a unit. This tubular member that rotates can be rigid or flexible depending on the type of borescope it surrounds.

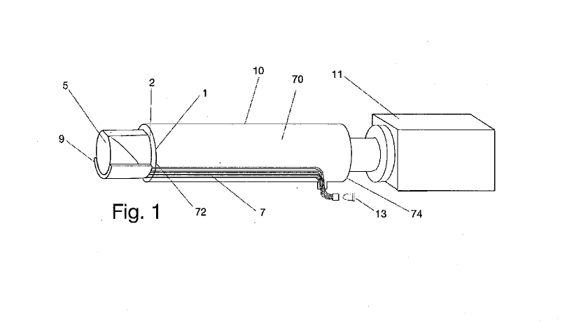

FIG. 1 illustrates a borescope 10 for use with the inspection system disclosed herein. The borescope 10 has an image conducting tube 70 populated with internal relay lenses (not visible) terminating at a distal end 72 and an opposing proximal end 74. A beamsplitter cube 5 at the distal end 72 of the image conducting tube 70 redirects the view of the borescope 10 by ninety degrees. Brightfield illumination is provided by a light guide 9 that accepts light from optical fibers 7 and redirects that light 90 degrees up and through the beamsplitter cube 5. The optical fibers 7 are channeled back away from beamsplitter cube 5 through a gap between an outer tube 1 and an inner tube 2 and exit the proximal end 74 of the borescope 70 where they are illuminated by a light source 13. A digital camera (11) captures the image from the borescope 70. The borescope 70 may be extended to any desired length with an addition of more internal relay lenses.

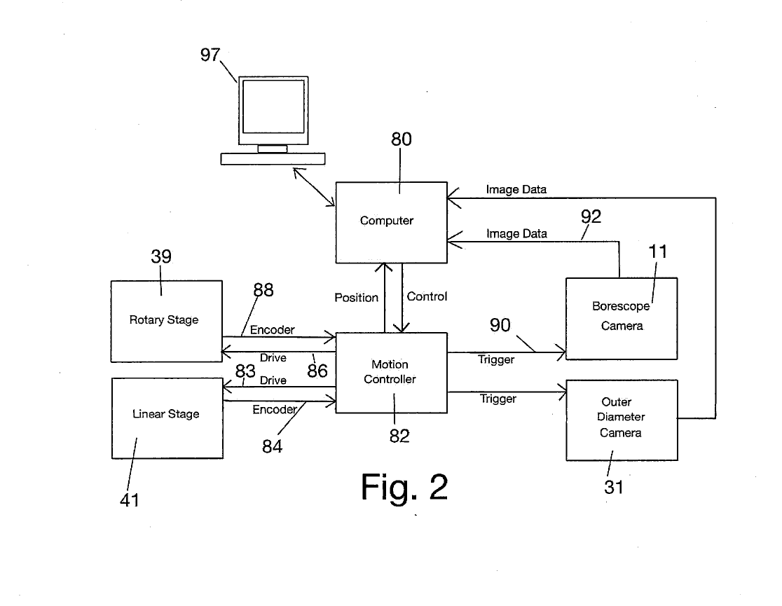

FIG. 2 illustrates in flowchart representation interaction between a computer 80 with a user interface 97 and a motion controller 82 of the inspection system. The computer 80 controls the motion controller 82 to direct the motions required by an inspection protoccol. During operation, the motion controller 82 drives a linear stage 41 by wired control 83 to position an object under inspection in the field of view of a borescope. An encoder signal 84 from the linear stage 41 assures correct positioning. Once the linear stage 41 is correctly positioned, the motion controller 82 drives rotary stage 39 by wired control 86 to rotate the object under inspection about the borescope. The motion controller 82 monitors an encoder signal 88 from the rotary stage 39 and at appropriate intervals sends a trigger 90 to the borescope camera 11 to acquire a section of image. The borescope camera 11 provides digital image data 92 to the computer 80 to display to an operator or conduct a quality assessment of the object being imaged. If the borescope camera 11 is an area camera than there will be a set of passed individual image data sets 92 passed to the computer 80. If the borescope camera 11 is a line camera, then the trigger signal 90 is sent to acquire each needed line to build a line-by-line digital image 92, which is then sent to the computer 80. If the inspection protocol calls for an image to be captured from an outer surface of the object under inspection this same process is repeated, except this time using an outer diameter camera 31.

Application software running on the computer 80 allows a user to interact with the inspection system via a user interface 97 and specify, axially and rotationally, what areas of the object to image. The software is further configured to stitch together multiple image data of an inner surface or an outer surface enabling the computer to display a single unrolled view of the inner bore of the object.

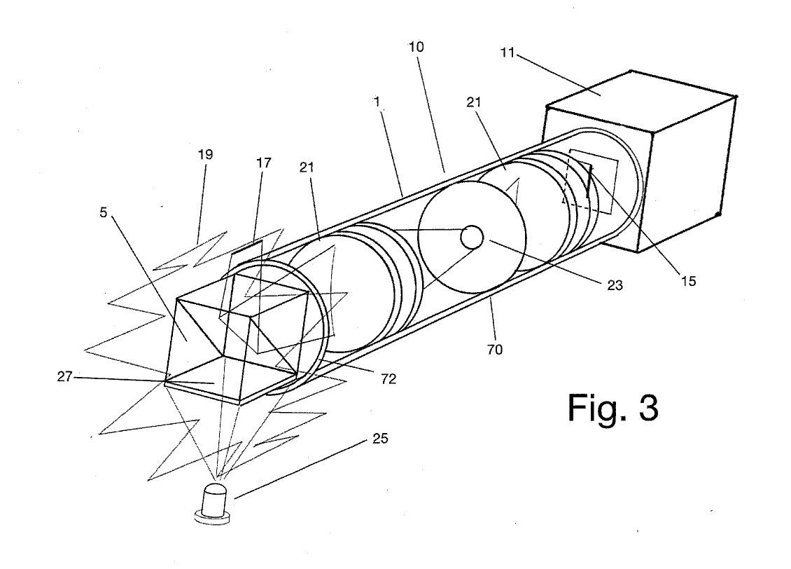

FIG. 3 shows a first embodiment of the inspection system. This embodiment is useful to inspect the inner diameters of generally cylindrical parts 19 that allow light to pass through, such as a stent or transparent or translucent glass tube. The borescope 10 has an outer tube 1 that contains a train of internal lenses 21 that utilize the beamsplitter cube 5 to pass along an image of the inner diameter of the part 19 to the digital camera 11. In this embodiment, the digital camera 11 is a line-scan type with a sensor 15 having a linear array of pixels. The beamsplitter cube 5 is placed at the distal end 72 of the image conducting tube 70 of the borescope 10 to align the linear sensor 15 with a linear field of view 17 such that as the part 19 is rotated around the borescope 10 a line-by-line image can be captured. To provide highly uniform diffuse illumination, a filter 27 diffuses the light provided by a light source 25 which then passes through the beamsplitter cube 5 and then onto the part 19. A telecentric aperture stop 23 is placed in the optical train to provide a constant magnification of the part 19.

FIG. 4 shows the part 19 held by a fixture 37 and rotated around the borescope 10 by a rotary stage 39 mounted on a linear stage 41 that can reposition the part 19 axially. The image from the borescope 10 is captured by digital camera 11 mounted on a precision alignment stage 29, that is mounted to a common base 43 for precision alignment of the borescope 10 in response to the travel of the linear stage 41. A second digital camera 31 mounted on a focusing stage 35 can be used to view the outer diameter of the part 19 through a lens 33. A precision Y-Z alignment stage 29 along with a tip-tilt adjustment 28 can align the borescope 10 with the X-Axis stage holding the rotary stage 39 to enable the borescope 10 to focus on and accommodate parts 19 of varying diameter and shape.

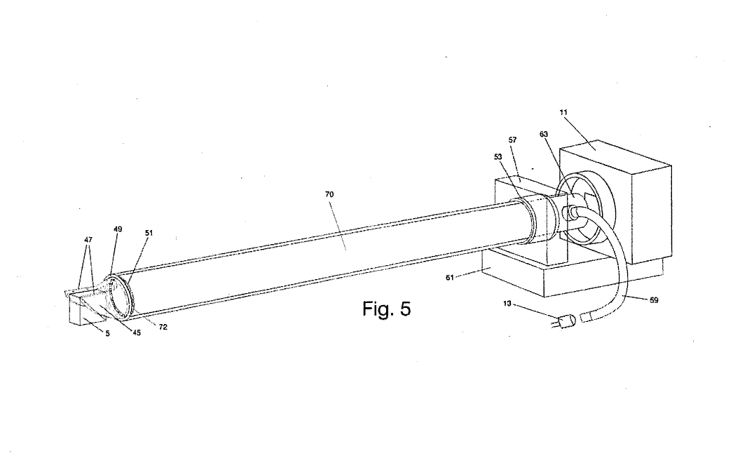

FIG. 5 shows a second embodiment of the inspection system. A borescope 63 with internal optical fibers 59 that truncate at the distal end 72 of the image conducting tube 70 expelling light in the form of a circular annulus 51 at the distal end 72. An acrylic plastic manifold 45 is generally silver coated except for an input annulus that is of similar size and held in close proximity to accept light from the fiber optic annulus 51. Also not silvered are exit windows 47, to direct light on to a part under inspection (not shown). A beamsplitter cube 5 provides a field of view of the inner diameter of the inspected part to the digital camera 11 and is sized in response to the manifold 45. An outer tube 49 extends the length of and is sized to slip fit around the image conducting tube 70. The beamsplitter cube 5 and the manifold 45 are together affixed to the outer tube 49 and rotated by a motor 57 with a hollow shaft 53. A light emitting diode LED light source 13 provides light to the optical fibers 59.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

We claim:

1. An inspection system for imaging an inner surface of an object, at least a portion of the object having general rotational symmetry, comprising:
a source of illumination;
a fixture configured to support said object;
a rotary stage configured to support said fixture, whereby rotation of the rotary stage rotates said object about a central cylindrical axis of said portion of the object that is generally rotationally symmetric;
a borescope having a reflector at the distal end thereof, the reflector redirecting a field of view of the borescope to capture a view of the inner surface of the object by a first digital camera located at a proximal end of said borescope;
a motion controller capable of collecting an encoder signal from the rotary stage and using that encoder signal to calculate a set of rotary positions at which to trigger the first digital camera to acquire image data; and
a computer programmed to receive and process said image data and capable of one or more of displaying and performing quality analysis of said processed image data.

2. The inspection system of claim 1 wherein a second digital camera is configured to image the outside of the part under inspection.

3. The inspection system of claim 3 wherein at least one of the first and second digital cameras is an area array sensor camera and computer displays said image as a mosaic of collected image data sections.

4. The inspection system of claim 2 wherein at least one of the first and second digital cameras is a linear array sensor and said computer constructs the image from the image data on a line-by-line basis.

5. The inspection system of claim 1 wherein a linear Z-axis stage is effective to provide relative motion between the object and the borescope to facilitating focus and accommodating objects of varying diameters and shapes.

6. The inspection system of claim 5 wherein a linear X-axis stage is effective to provide relative axial motion along the central cylindrical axis between said object and the borescope enabling different sections of the inner surface to be imaged.

7. The inspection system of claim 6 wherein application software running on said computer allows a user to interact with the inspection system and specify, axially and rotationally, what areas of the object to image, the software further configured to stitch together multiple image data of an inner bore or an outer diameter enabling the computer to display a single unrolled view of the inner bore of the object.

8. The inspection system of claim 1 wherein a telecentric stop is aligned with an objective lens of the borescope to provide images with fixed magnification.

9. A borescope having an image conducting tube with a beamsplitter cube adjacent a distal end of the image conducting tube, said borescope configured to view an inner surface of an object disposed adjacent a first side of the beamsplitter cube and having a light source effective to provide light illuminating said inner surface from an opposing second side of the beamsplitter cube.

10. The borescope of claim 9 wherein said object is at least partially transparent or translucent and the light source directs the light at said beamsplitter cube from outside an outer surface of said object under inspection.

11. The borescope of claim 9 wherein said beamsplitter cube is rounded to be responsive to the shape of the image conducting tube of the borescope.

12. The borescope of claim 9 wherein a diffuser is disposed between said light source and said beamsplitter cube.

13. The borescope of claim 9 wherein the light source is a plurality of optical fibers conducting light from a proximal end of the image conducting tube of the borescope to the distal end and light from said plurality of optical fibers is coupled into a diffuser and that emits light through said beamsplitter cube to provide illumination on the inner surface to be imaged.

14. The borescope of claim 13 wherein said diffuser includes a side-illuminated display backlight redirecting film.

15. A borescope configured to view an inner surface of an object under inspection, comprising:
an image conducting tube with a reflector adjacent a distal end thereof;
an outer tube circumscribing said image conducting tube capable of independent rotatation around said image conducting tube;
a plurality of optical fibers forming a light conduit mounted to optics effective to transmit light from a proximal end of said image conducting tube to said distal end thereof, the light exiting through an annulus at the distal end;
an input window of said light conduit responsive in shape to collect light from said optical fibers; and
a motor effective to rotate said outer tube, reflector and light conduit so as to acquire image data anywhere along 360 degrees of the inner diameter of the said object.
